(19) United States
(12) Patent Application Publication
(10) Pub. No.: US 2007/0109035 A1
(43) Pub. Date: May 17, 2007

(54) Charge pump

(76) Inventor: Michael Tsivyan, Cupertino, CA (US)

Correspondence Address: DLA PIPER RUDNICK GRAY CARY US, LLP, 2000 UNIVERSITY AVENUE, E. PALO ALTO, CA, 94303-2248, US

(21) Appl. No.: 11/281,224

(22) Filed: Nov. 16, 2005

(51) Int. Cl. G05F 1/10

(52) U.S. Cl. 327/536

(57) ABSTRACT

A charge pump has a number of serially connected pumping stages, with each stage having a pair of cross coupled inverters having a first input and a second input. Each inverter has a N channel transistor having a first end and a second end, and a P channel transistor having a first end and a second end with the first end of the N channel transistor connected to the first end of the P channel transistor. A first capacitor having a first end is connected to the first input and receives a first clock signal at a second end. A second capacitor, different in size from the first capacitor, having a first end is connected to the second input and receives a second clock signal at a second end. The second end of the P channel transistor of one of the inverters is connected to the second end of the N channel transistor of one of the inverters of an adjacent stage. The second end of the P channel transistor of another of the inverters is connected to the second end of the N channel transistor of another of the inverters of an adjacent stage.

### TECHNICAL FIELD

The present invention relates to a charge pump, and more particularly, to a charge pump having capacitors split unevenly, allowing optimization for better power efficiency, speed and area.

### BACKGROUND OF THE INVENTION

Charge pumps are well known in the art. Charge pumps are used to pump a voltage from a first level to a second level. Typically charge pumps are used in non-volatile memories to increase the voltage from a source so that the increased voltage can be used to program or to erase selected cells in the memory.

Referring to FIG. 1 there is shown a schematic circuit diagram of a charge pump 10 of the prior art. The pump 10 comprises a plurality of serially connected like stages 20 (a-f). Each stage, 20a, comprises a pair of cross coupled inverters. Further, the pair of cross coupled inverters has a first input 22a, and a second input 24a. A capacitor 26a has two ends, with one end connected to the first input 22a, and another end 28a for receiving a clock signal CLK2. A capacitor 30a has two ends, with one end connected to the second input 24a, and another end 32a for receiving a clock signal CLK1. Each of the capacitors 26a and 30a is of the same size. Further, the clock signal CLK1, is connected to the ends 32a of each capacitor 30a, and the clock signal CLK2 is connected to the ends 28a of each capacitor 26a.

Each inverter of the pair of cross coupled inverters has a N channel transistor having a first end and a second end, and a P channel transistor having a first end and a second end. The N channel transistor is connected in series with the P channel transistor, with the first end of the N channel transistor connected to the first end of the P channel transistor. Each of the N channel transistor and the P channel transistor has a gate, with the gates connected together and to the first end of the N channel transistor of the other inverter. The second ends of the N channel transistors of the two inverters in a stage 20a are connected together. The second ends of the P channel transistors of the two inverters in a stage 20a are connected together and to the second end of the N channel transistors of an immediately adjacent stage 20b. The second end of the N channel transistors of the first stage 20a is connected to a voltage source supplying Vdd. The second end of the P channel transistor of the final stage 20f is connected to another capacitor 40 which supplies the pumped voltage.

### SUMMARY OF THE INVENTION

In the present invention, a charge pump comprises a plurality of like stages which are connected in series. Each stage comprises a pair of cross coupled inverters having a first input and a second input. Each inverter comprises a N channel transistor having a first end and a second end, and a P channel transistor having a first end and a second end with the first end of the N channel transistor connected to the first end of the P channel transistor. A first capacitor has a first end and a second end. The first end is connected to the first input with the second end receiving a first clock signal. A second capacitor, different in size from the first capacitor, has a first end and a second end. The first end is connected to the second input with the second end receiving a second clock signal. The second end of the P channel transistor of one of the inverters is connected to the second end of the N channel transistor of a corresponding inverter of an adjacent stage. The second end of the P channel transistor of another of the inverters is connected to the second end of the N channel transistor of a corresponding inverter of an adjacent stage.

### BRIEF DESCRIPTION OF THE DRAWINGS

FIG. 1 is a circuit diagram of a charge pump of the prior art.

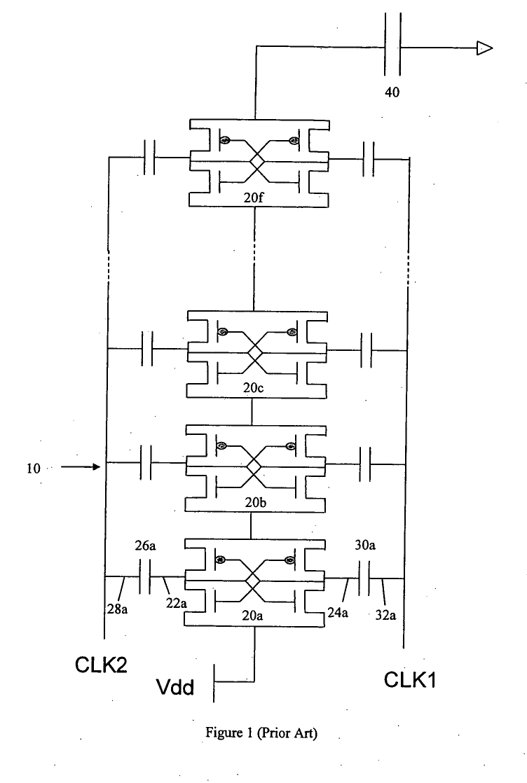

FIG. 2 is a circuit diagram of a charge pump of the present invention.

FIG. 3 is a graph showing the improvement in area and power consumption by reducing the connected capacitors by 12% with no impact on efficiency of 1, 2, and 3 stage charge pump of the present invention compared to the charge pump of the prior art.

FIG. 4 is a graph showing the improvement in time and final voltage with no impact on area and power consumption of 1, 2, and 3 stage pumps of the present invention compared to the charge pump of the prior art.

### DETAILED DESCRIPTION OF THE INVENTION

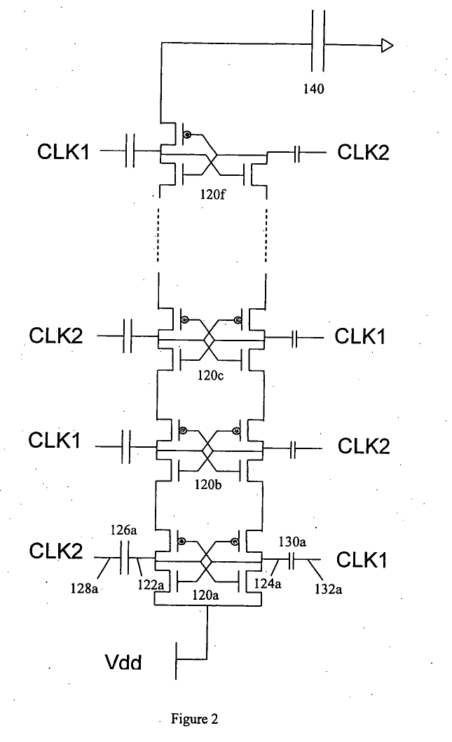

Referring to FIG. 2, there is shown a circuit diagram of a charge pump 110 of the present invention. The pump 110 comprises a plurality of serially connected like stages 120 (a-f). Each stage, 120a, comprises a pair of cross coupled inverters. Further, the pair of cross coupled inverters has a first input 122a, and a second input 124a. A capacitor 126a has two ends, with one end connected to the first input 122a, and another end 128a for receiving a clock signal CLK2. A capacitor 130a has two ends, with one end connected to the second input 124a, and another end 132a for receiving a clock signal CLK1. Each of the capacitors 126a and 130a is of a different size. In the example shown, capacitor 130a is smaller than the capacitor 126a. Further, the clock signal CLK1, is connected to the end 132a of capacitor 130a of stage 120a, and to the end 128b of capacitor 126b of stage 120b, and to the end 132c of capacitor 130c of stage 120c and so on. The clock signal CLK2 is connected to the end 128a of capacitor 126a of stage 120a, and to the end 132b of capacitor 130b of stage 120b, and to the end 128c of capacitor 126c of stage 120c, and so on. Thus the clock signals CLK1 and CLK2 are connected to alternate inputs of each stage 120.

Each inverter of the pair of cross coupled inverters has a N channel transistor having a first end and a second end, and a P channel transistor having a first end and a second end. The N channel transistor is connected in series with the P channel transistor, with the first end of the N channel transistor connected to the first end of the P channel transistor. Each of the N channel transistor and the P channel transistor has a gate, with the gates connected together and to the first end of the N channel transistor of the other inverter. The second ends of the P channel transistors of the two inverters in a stage 20a are connected to the respective second ends of the N channel transistors of an immediately adjacent stage 20b. Further, the N and P channel transistors whose first ends are connected together and to the end 124a of the capacitor 130a are smaller in size than the N and P channel transistors in the same stage.

The second ends of the N channel transistors of the first stage 20a are connected to a voltage source supplying Vdd.

The final stage 120f has one inverter with a N channel transistor and a P channel transistor, and a second inverter with only a single N channel transistor. The gates of the N and P channel transistors are connected to the first end of the N channel transistor of the other inverter. The gate of the N channel transistor of the other inverter is connected to the first end of the N channel transistor of the one inverter. The second end of the P channel transistor is connected to another capacitor 140 which supplies the pumped voltage.

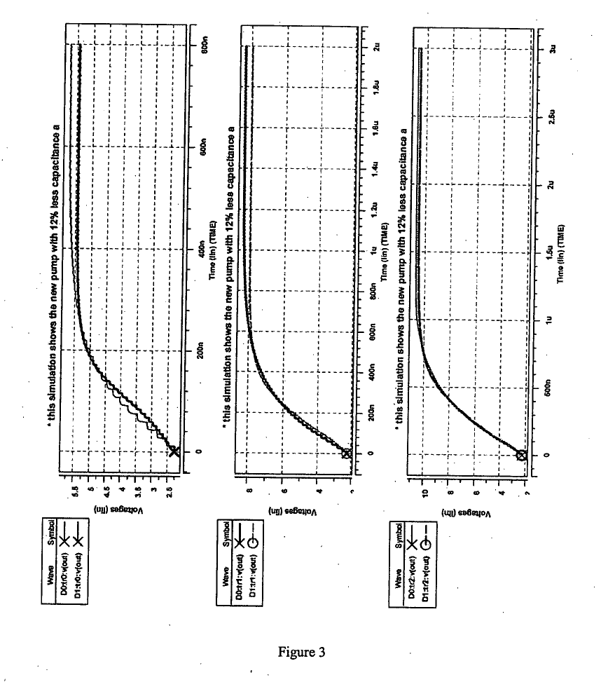

Referring to FIG. 3 there is shown a graph of time vs. voltage showing the improvement in area and power consumption by reducing the connected capacitors by 12% with no impact on efficiency of 1, 2, and 3 stage charge pump of the present invention compared to the charge pump of the prior art.

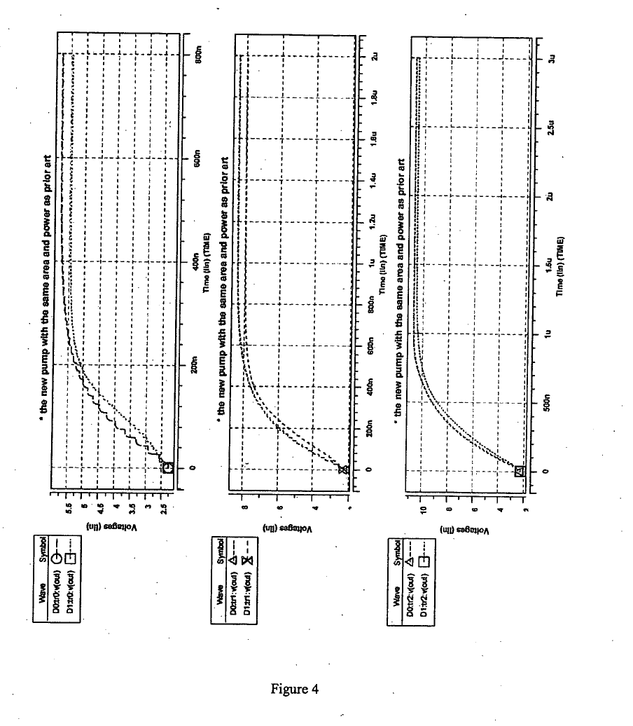

Referring to FIG. 4 there is shown a graph of time vs. voltage showing the improvement in time and final voltage with no impact on area and power consumption of 1, 2, and 3 stage pumps of the present invention compared to the charge pump of the prior art.

As can be seen from FIGS. 3 and 4, the advantage of the charge pump 110 of the present invention compared to the pump 10 of the prior art is that there is improvement in area and power consumption, as well as efficiency.

What is claimed is:

1. A charge pump comprising:
a plurality of like stages, connected in series, each stage comprising:
a pair of cross coupled inverters having a first input and a second input, wherein each inverter comprising a N channel transistor having a first end and a second end, and a P channel transistor having a first end and a second end with said first end of said N channel transistor connected to the first end of said P channel transistor;
a first capacitor having a first end connected to said first input and for receiving a first clock signal at a second end;
a second capacitor, different in size from said first capacitor, having a first end connected to said second input and for receiving a second clock signal at a second end;
wherein said second end of said P channel transistor of one of said inverters is connected to the second end of said N channel transistor of one of said inverters of an adjacent stage; and
wherein said second end of said P channel transistor of another of said inverters is connected to the second end of said N channel transistor of another of said inverters of an adjacent stage.

2. The charge pump of claim 1 wherein said first clock signal supplied to said second end of said first capacitor of one stage is the same signal as the second clock signal supplied to said second end of said second capacitor of an immediately connected adjacent stage.

3. The charge pump of claim 1 wherein one of said inverters has a N channel transistor and a P channel transistor, each with a gate connected together and connected to the first end of the N channel transistor of another inverter.

4. The charge pump of claim 3 wherein the other of said inverters has a N channel transistor and a P channel transistor, each with a gate connected together and connected to the first end of the N channel transistor of the one inverter.

5. The charge pump of claim 4 wherein said first capacitor is smaller in size than said second capacitor.

6. The charge pump of claim 5 wherein each of said N channel transistor and P channel transistor of one of said inverters is connected to said first end of said first capacitor, and is smaller in size than the N channel transistor and P channel transistor of the other inverter.

7. The charge pump of claim 6, wherein said plurality of like stages has a first stage and a last stage, wherein said second ends of said N channel transistors of said first stage is connected to a voltage source of Vdd.

8. The charge pump of claim 6, further comprising:
a final inverter comprising a N channel transistor, having a first end and a second end, and a P channel transistor having a first end and a second end, each with a gate connected together, and with the first end of the N channel transistor connected to the first end of the P channel transistor;
a final N channel transistor having a first end and a second end, and a gate, with the gate connected to the first end of the N channel transistor of said final inverter, and with the first end connected to the gates of said N channel transistor and P channel transistor of said final inverter;
a first capacitor having a first end connected to said first end of said N channel transistor and P channel transistor of said final inverter, and for receiving a first clock signal at a second end;
a second capacitor, different in size from said first capacitor, having a first end connected to said first end of said final N channel transistor and for receiving a second clock signal at a second end;
a final capacitor;
wherein said second end of said P channel transistor is connected to said final capacitor; and
wherein said second end of said P channel transistor of said final stage is connected to the second end of said N channel transistor and second end of said final N channel transistor, respectively.
